(19) United States
(12) Patent Application Publication
(10) Pub. No.: US 2018/0165622 A1
(43) Pub. Date: Jun. 14, 2018

(54) ACTION ANALYSIS DEVICE, ACTON ANALYSIS METHOD, AND ANALYSIS PROGRAM

(71) Applicant: NEC Corporation, Minato-ku, Tokyo (JP)

(72) Inventor: Toshiya OKABE, Tokyo (JP)

(73) Assignee: NEC Corporation, Minato-ku, Tokyo (JP)

(21) Appl. No.: 15/575,498

(22) PCT Filed: May 19, 2016
(86) PCT No.: PCT/JP2016/002452

§ 371 Date: Nov. 20, 2017

(30) Foreign Application Priority Data
Jun. 10, 2015 (JP) 2015-117230

(51) Int. Cl. G06Q 10/06

(52) U.S. Cl. CPC G06Q 10/063112; G06Q 10/063114

(57) ABSTRACT

Provided is an action analysis device (10), comprising an acquisition unit (11) which acquires sounds, and an analysis unit (12) which analyzes the frequency of the acquired sounds per predetermined time interval. The analysis unit (12) compares frequency distributions of frequency components within each frequency distribution which is a frequency analysis result, said frequency components corresponding to work sounds which are emitted in a predetermined task which a subject perform, and thereby generates information which denotes a change in time required for the predetermined task of the subject over elapsed time.

### TECHNICAL FIELD

The present invention relates to an action analysis device, an action analysis method, and an action analysis program, which target a worker individual, and more particularly, to an action analysis device, an action analysis method, and an action analysis program, by which it is possible to digitize a change in productivity of a task due to an influence of a proficiency level for the task of a worker or fatigue of the worker without increasing a burden of the worker, and to notify the digitized value.

### BACKGROUND ART

An example of a general movement analysis device is disclosed in Patent Literature 1 to Patent Literature 3.

Patent Literature 1 discloses an operation analyzing device that reduces a time required for operation analysis. In the operation analyzing device disclosed in Patent Literature 1, one cycle is specified a plurality of times based on a standard cycle from an operation orbit of an operator who is performing an operation of which operation sequence may be changed, so that operation analysis becomes easy and a time required for the operation analysis is reduced.

Patent Literature 2 discloses a work evaluation device that supports evaluation of work content by extracting target work actions of interest from video information derived from a small amount of actual work photography.

The work evaluation device disclosed in Patent Literature 2 receives worker's standard work information based on a production plan. Furthermore, the work evaluation device captures a worker's work condition as a video.

The work evaluation device automatically detects the condition of workpieces within a work area around a worker and stores the detected condition of workpieces, the video frame information, and the standard work information in association. On the basis of the associated and stored video frame information, the standard work information, and the condition of workpieces, work done by the worker is evaluated.

Patent Literature 3 discloses an action analysis device that captures and analyzes action of a worker and provides analysis data to be used for finding out problems in working action and procedure and improving the problems.

The action analysis device disclosed in Patent Literature 3 divides a movement track of a captured subject within a reference video for each work in which a series of movements are continuously performed, and extracts and stores characteristic information of a track in a division timing of each individual movement constituting a series of movements. Next, the action analysis device extracts a division timing of each movement by using the characteristic information from a video obtained by capturing another worker who performs the same work, integrates the movement based on movement information included in work indicated by the reference video, and analyzes a time required for each work.

As described above, a general action analysis device collates a video obtained by capturing work states of workers with predetermined reference video and predetermined reference track. Through the collation, the action analysis device detects work of a worker deviated from predetermined reference and notifies a supervisor and the like of the detection result.

Furthermore, the action analysis device may calculate a time required for worker's each process from the video obtained by capturing the work states of the workers. The action analysis device collates the time required for each process with a reference time calculated from the reference video and the reference track, thereby detecting work corresponding to working hours deviated from the reference time and notifies a supervisor and the like of the detection result.

Furthermore, in the case of using the action analysis device disclosed in Patent Literature 3, it is necessary to install a mark serving as a sign at a part of a worker's body. The action analysis device extracts a characteristic video and a track of the mark from a video obtained by capturing work content of a worker.

The aforementioned action analysis device has the following two problems.

First, since it is necessary to install a sign such as a mark or a special sensing device at a subject or around the subject at the time of use, an installation load occurs in the subject. The reason for installing the mark and the like is because the action analysis device measures a motion of hands and feet or a body of the subject or a motion of an instrument such as a jig used by a worker and thus the object needs to be inconspicuous.

Second, since it is necessary to prepare in advance a reference for a captured video, a time is required for preparing the reference. This is because the analysis of the action analysis device includes a process for comparing the video with the reference and it is determined whether working action of a worker deviates from a normal state in the process.

### CITATION LIST

### Patent Literature

[PTL 1] Japanese Unexamined Patent Application Publication No. 2009-015529

[PTL 2] Japanese Unexamined Patent Application Publication No. 2005-242418

[PTL 3] U.S. Pat. No. 5,525,202

[PTL 4] Japanese Unexamined Patent Application Publication No. 2010-102097

[PTL 5] U.S. Pat. No. 5,027,053

### SUMMARY OF INVENTION

### Technical Problem

A technology for solving the aforementioned first problem is disclosed in Patent Literature 4. The Patent Literature 4 discloses a portable communication device capable of extracting only a light source having a change in color information as a characteristic point. The portable communication device disclosed in Patent Literature 4, for example, extracts a pixel in which luminance or brightness decided in advance has changed more than a predetermined value.

That is, the action analysis device employing the technology disclosed in Patent Literature 4 is able to understand the motion of the hands and feet or the body of the subject or movement of the instrument such as a jig used by the worker from the change in the color information in the captured video. Thus, the first problem is solved without installing the mark and the like at the subject or around the subject at the time of use.

Furthermore, a technology for solving the aforementioned second problem is disclosed in Patent Literature 5. The Patent Literature 5 discloses a work analyzer that evaluates ability and states of each worker by calculating a statistical value on the basis of work records of each worker.

Specifically, the work analyzer disclosed in Patent Literature 5 calculates a dispersion value and a standard deviation value of record values of work duration times at arbitrary time intervals or in arbitrary time periods from work duration times for each work type such as each process type and each product type of each worker. The work analyzer employs the calculated dispersion value and standard deviation value as an index value indicating the degree of a variation of the work duration times for each work type of each worker in predetermined time periods.

That is, the action analysis device employing the technology disclosed in Patent Literature 5 is able to evaluate work content of a worker by using only acquired data. Thus, the second problem is solved without preparing any references for the captured video in advance.

A method using a video obtained by capturing work of a worker is proper for precise analysis because large amount of information can be acquired. However, since the acquired information is large, it is disadvantageous that time is required for processing or a transmission load of video data is large.

It is considered to use sounds generated in the work of the worker instead of using the video obtained by capturing the work of the worker. Even in the case of using the sounds, the action analysis device can evaluate the work content of the worker. Since the sounds are one-dimensional data, it is easily processed. Furthermore, since the amount of the acquired information is small, a data transmission load is smaller than that of the video.

The method using the sounds is also advantageous that it is implemented with an inexpensive and small sensor as compared with the method using the video. However, in the movement analysis devices disclosed in Patent Literature 1 to Patent Literature 3, it is not assumed to use the sounds generated in the work of the worker.

Therefore, an object of the present invention is to provide an action analysis device, an action analysis method, and an action analysis program, by which it is possible to understand a change in a time required for a task due to an influence of a proficiency level or fatigue by using no reference value without applying a large burden to a subject.

### Solution to Problem

An aspect of the invention is an action analysis device. The action analysis device comprises an acquisition unit that acquires sounds; and an analysis unit that analyzes a frequency of the acquired sounds per predetermined time interval. The analysis unit compares frequency distributions of frequency components within each frequency distribution which is a frequency analysis result. The frequency components is corresponding to a work sound generated in a predetermined task performed by a subject. Thereby the analysis unit generates information indicating a change in a time required for the predetermined task of the subject with passage of time.

An aspect of the invention is an action analysis method. The action analysis method comprises acquiring sounds, analyzing a frequency of the acquired sounds per predetermined time interval, and comparing frequency distributions of frequency components within each frequency distribution which is a frequency analysis result. The frequency components is corresponding to a work sound generated in a predetermined task performed by a subject. The action analysis method further comprises generating information indicating a change in a time required for the predetermined task of the subject with passage of time.

An aspect of the invention is an action analysis program. The action analysis program causes a computer to perform an acquisition process for acquiring sounds, an analysis process for analyzing a frequency of the acquired sounds per predetermined time interval, and a generation process for comparing frequency distributions of frequency components within each frequency distribution which is a frequency analysis result. The frequency components is corresponding to a work sound generated in a predetermined task performed by a subject. The action analysis program thereby causes the computer to perform generating information indicating a change in a time required for the predetermined task of the subject with passage of time.

### Advantageous Effects of Invention

According to the present invention, it is possible to understand a change in a time required for a task due to an influence of a proficiency level or fatigue by using no reference value without applying a large burden to a subject.

### BRIEF DESCRIPTION OF DRAWINGS

FIG. 1 is a block diagram illustrating a configuration example of a first example embodiment of an action analysis device according to the present invention.

FIG. 2 is a flowchart illustrating an operation of an analyzing process by an action analysis device 100 of a first example embodiment.

FIG. 3 is an explanation diagram illustrating an example of a daily variation of working hours required for a worker's task.

FIG. 4 is a block diagram illustrating a configuration example of a second example embodiment of an action analysis device according to the present invention.

FIG. 5 is a flowchart illustrating an operation of an analyzing process by an action analysis device 100 of a second example embodiment.

FIG. 6 is a block diagram illustrating a configuration example of a third example embodiment of an action analysis device according to the present invention.

FIG. 7 is a flowchart illustrating an operation of an analyzing process by an action analysis device 100 of a third example embodiment.

FIG. 8 is a block diagram illustrating a configuration example of a fourth example embodiment of an action analysis device according to the present invention.

FIG. 9 is a flowchart illustrating an operation of an analyzing process by an action analysis device 100 of a fourth example embodiment.

FIG. 10 is a block diagram illustrating a configuration example of the present example of an action analysis device according to the present invention.

FIG. 11 is an explanation diagram illustrating an example of frequency distributions for periods calculated by an analysis unit 205 in the present example.

FIG. 12 is a block diagram illustrating an outline of an action analysis device according to the present invention.

### DESCRIPTION OF EMBODIMENTS

### Example Embodiment 1

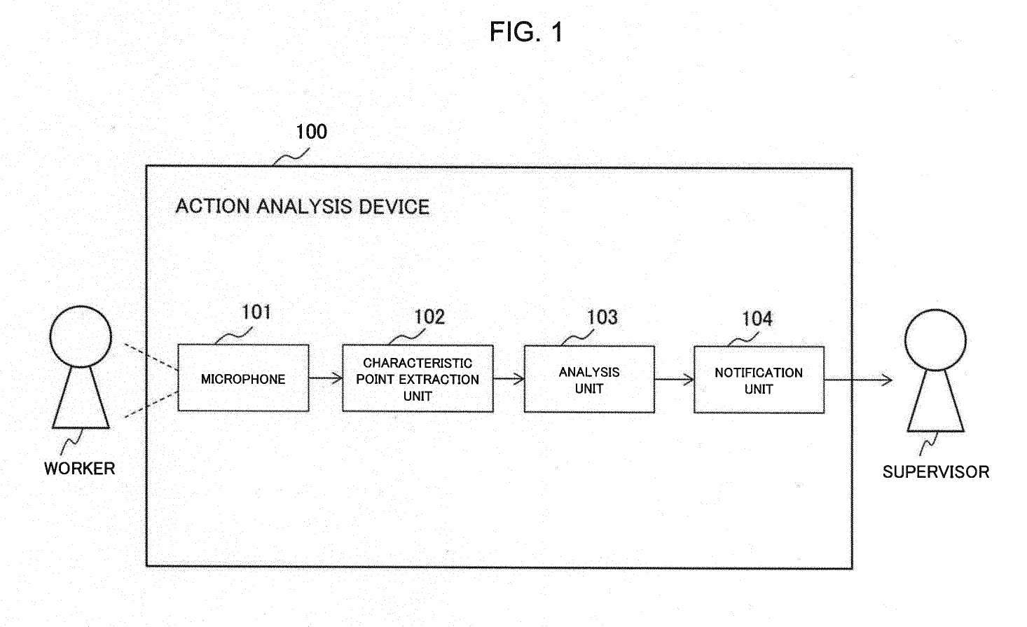

Hereinafter, example embodiments of the present invention will be described with reference to the drawings. FIG. 1 is a block diagram illustrating a configuration example of a first example embodiment of an action analysis device according to the present invention.

An action analysis device 100 illustrated in FIG. 1 includes a microphone (hereinafter, referred to as a mike) 101, a characteristic point extraction unit 102, an analysis unit 103, and a notification unit 104.

For example, a case, where a worker performs a task for taking parts a out of a box A, taking parts b out of a box B, combining the parts a with the parts b, and putting the combined parts into a box c, will be considered.

It is assumed that sounds and vibration are generated in the actions for taking the parts a out of the box A, taking the parts b out of the box B, combining the parts a with the parts b, and putting the combined parts into the box c. When a sound detection sensor has been installed on a desk and the like on which the worker performs the task, the installed sensor can detect the vibration as sounds as well as audible sounds.

When the sounds and the vibration are generated in each action of the worker, if intervals and the like of work sounds generated around the worker repeating the same task are compared with each other for example, it is considered to be able to understand a change in the productivity of the worker.

The mike 101 has a function of collecting sounds including the work sounds generated in the worker's task for a predetermined time. The mike 101, for example, collects sounds around a worker in a factory. The mike 101 inputs the collected sounds to the characteristic point extraction unit 102.

The mike 101 may have a function of recording the collected sounds. In the aforementioned example, when the mike 101 in a record mode has been installed at a work table, the mike 101 can record sounds and vibration generated in a task.

Furthermore, since a portable terminal is mounted with a sound detection device in many cases, the action analysis device 100 may also use the device mounted at the portable terminal as the mike 101.

The characteristic point extraction unit 102 has a function of extracting a sound, in which a time change is large, from the sounds inputted from the mike 101.

For example, when the mike 101 includes a plurality of sound collection units (not illustrated), the mike 101 can simultaneously collect different types of sounds. The characteristic point extraction unit 102 extracts only a sound, in which a time change is large, from a plurality of inputted sounds. The action analysis device 100 may not include the characteristic point extraction unit 102.

The analysis unit 103 has a function of calculating an index indicating an influence of a proficiency level, fatigue and the like of a worker on the productivity of a task. In the present example embodiment, the analysis unit 103 performs frequency analysis for analyzing a time change amount (time series data) of volume of a sound, a time change amount of volume of a predetermined musical interval, a time change amount of a musical interval, and the like into frequency components.

The analysis unit 103 performs the frequency analysis, thereby generating frequency distributions in which the frequency of each frequency component is illustrated. Furthermore, the analysis unit 103 may generate the frequency distribution in which the frequency of each frequency component is illustrated.

The analysis unit 103 can calculate the index indicating the influence of a proficiency level, fatigue and the like of a worker on the productivity of a task, by using the generated frequency distributions. A detailed index calculation method will be described in description of operations and examples to be described later.

The notification unit 104 has a function of notifying a supervisor and the like of the worker of the calculation result by the analysis unit 103.

The action analysis device 100 of the present example embodiment, for example, is implemented by a central processing unit (CPU) that performs processes according to programs stored in a storage medium. That is, the mike 101, the characteristic point extraction unit 102, the analysis unit 103, and the notification unit 104, for example, are implemented by the CPU that performs processes according to program control.

Furthermore, each element of the action analysis device 100 may be implemented by hardware circuits.

Furthermore, as the mike 101, it is possible to use a portable telephone such as a smart phone including a sound collection function and a sound recording function.

### [Description of Operation]

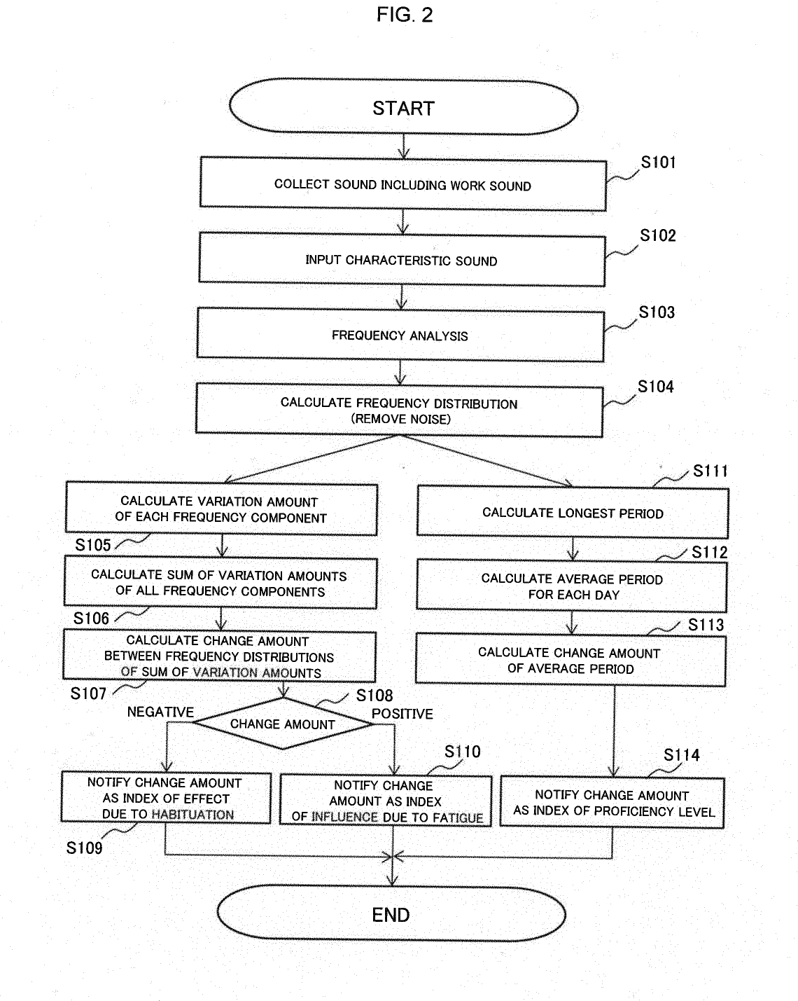

Hereinafter, the operations of the action analysis device 100 of the present example embodiment will be described with reference to FIG. 2. FIG. 2 is a flowchart illustrating operations of the analyzing process by the action analysis device 100 of the first example embodiment.

The mike 101 collect sounds, which include work sounds generated in a worker's task, for a predetermined time (step S101). In step S101, the mike 101 may record the collected sounds.

Next, the mike 101 inputs the collected sounds to the characteristic point extraction unit 102. In addition, the mike 101 may input the recorded sounds to the characteristic point extraction unit 102.

Next, the characteristic point extraction unit 102 extracts a sound, in which a time change is large, from the inputted sounds. The characteristic point extraction unit 102 inputs the extracted sound to the analysis unit 103 (step S102).

Next, the analysis unit 103 performs frequency analysis with respect to a time change amount in the inputted sound, thereby analyzing the time change amount into frequency components (step S103). As a method for analyzing the time change amount into the frequency components, the analysis unit 103 uses Fourier transform for example.

In the example illustrated in FIG. 2, the analysis unit 103 performs frequency analysis with respect to the sound per one hour. The analysis unit 103 repeatedly performs the frequency analysis with respect to all the inputted sounds.

The frequency analysis is repeatedly performed, so that a plurality of frequency distributions of frequency components based on the sounds corresponding to one hour are generated. The analysis unit 103 determines frequency components, of which frequency is equal to or less than a predetermined value, as noise and removes the frequency components from the generated frequency distributions (step S104).

After the process of step S104, the analysis unit 103 performs calculation of a variation amount of the frequency components and calculation of the longest period in the generated each frequency distribution in a parallel manner.

The analysis unit 103 selects a plurality of frequency components with large frequency in the generated each frequency distribution. The analysis unit 103 calculates variation amounts of the selected each frequency component (step S105). In addition, the analysis unit 103 may calculate variation amounts of all the frequency components.

For example, the analysis unit 103 calculates the degree of separation, by which frequency components with a predetermined ratio of frequency (for example, 80%) of the frequency of the selected frequency components are separated from the selected frequency components, as a variation amount. The unit of the variation amount may have any units if the variation amount corresponds to a distance between the frequency components.

Next, the analysis unit 103 calculates the sum of the variation amounts of each frequency component, which are calculated in each frequency distribution, per each frequency distribution (step S106).

Next, the analysis unit 103 calculates a change amount of the calculated sum of the variation amounts (step S107). Specifically, the analysis unit 103 checks a change in the sum of the variation amounts as the working hours elapse.

Next, the analysis unit 103 determines whether the calculated change amount of the sum of the variation amounts with the passage of time is negative (step S108). That is, the analysis unit 103 determines whether the sum of the variation amounts is decreased as the working hours elapse.

When the change amount of the sum of the variation amounts with the passage of time is negative, that is, it is determined that the sum of the variation amounts is decreased (negative in step S108), the notification unit 104 notifies the calculated change amount of the sum of the variation amounts as an index of effect due to habituation (step S109).

The change amount of the sum of the variation amounts notified by the notification unit 104 represents that the effect due to habituation is generated for a predetermined task of a subject. For example, the change amount of the sum of the variation amounts may include character information “effect due to habituation for predetermined task of subject”.

The reason for notifying the calculated change amount of the sum of the variation amounts as the index of the effect due to habituation is that times required for tasks of each time are easily uniformed in the case of a worker experienced in a task. In the example of the aforementioned task, times, which are required for each task such as times for which a worker inexperienced in a task checks a position of a box A and a position of a box B, times for which the worker grasps parts in boxes, and times for which the worker combines parts a with parts b, are difficult to be uniformed in each time.

However, since a worker experienced in a task can always process each task at a predetermined speed, times required for tasks of each time are easily uniformed. That is, if a worker is experienced in a task, the sum of the variation amounts calculated in the frequency distributions is decreased. Therefore, it is proper to notify the change amount as the index of the effect due to habituation.

When the change amount of the sum of the variation amounts with the passage of time is positive, that is, it is determined that the sum of the variation amounts is increased (positive in step S108), the notification unit 104 notifies the calculated change amount of the sum of the variation amounts as an index of an influence due to fatigue (step S110).

The change amount of the sum of the variation amounts notified by the notification unit 104 represents that an influence due to fatigue of a subject occurs. For example, the change amount of the sum of the variation amounts may include character information “influence due to fatigue of subject”.

The reason for notifying the calculated change amount of the sum of the variation amounts as the index of the influence due to fatigue is that for example, if a worker is fatigued, a wasteful task, such as grasping and damaging of parts and re-grasping of parts after falling the parts, irregularly occurs in many cases.

If it is less probable that a worker can repeatedly perform a task in the same time, times required for tasks of each time are difficult to be uniformed. That is, if the worker is fatigued, the sum of the variation amounts calculated in the frequency distributions is increased. Therefore, it is proper to notify the change amount as the index of the influence due to fatigue.

Furthermore, the analysis unit 103 calculates the longest period in the each generated frequency distribution (step S111). Specifically, the analysis unit 103 selects a frequency component with a minimum value from frequency components, of which frequency is equal to or more than the predetermined value. The analysis unit 103 calculates a reciprocal of the selected frequency component as the longest period in the frequency distribution. The calculated longest period corresponds to a time required for performing a one-time task.

Next, the analysis unit 103 calculates an average value of the longest periods calculated in each frequency distribution (step S112). For example, the analysis unit 103 calculates an average value of the longest periods of each working day.

Next, the analysis unit 103 calculates a change amount of the average value of the longest periods with the passage of working hours (step S113).

Next, the notification unit 104 notifies the calculated change amount of the average value of the longest periods as an index of a proficiency level for a worker's task (step S114).

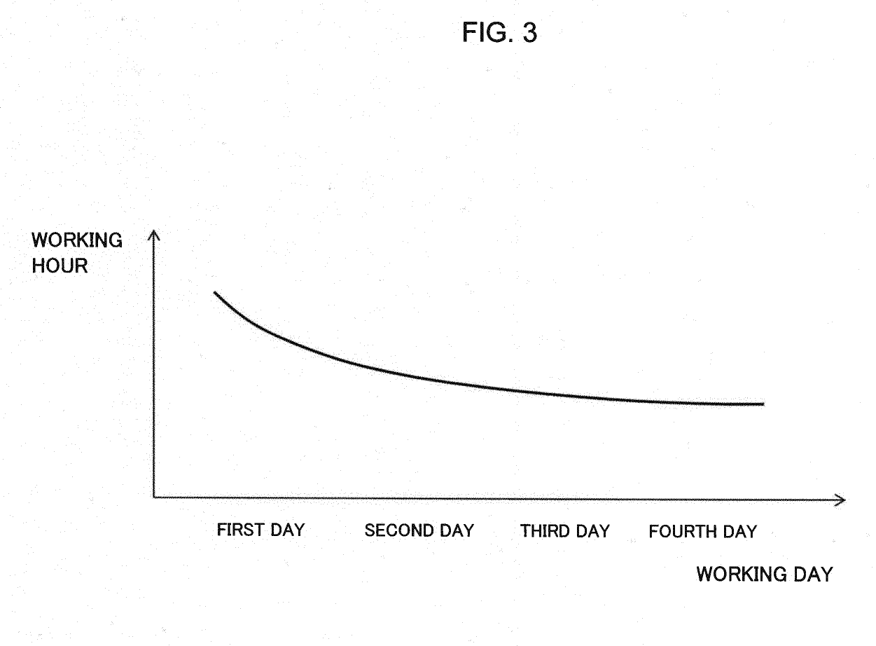

FIG. 3 is an explanation diagram illustrating an example of a daily variation of working hours required for a worker's task. As illustrated in FIG. 3, it is assumed that a worker, for example, can perform a task, which requires average 10 seconds on the first day, in a time (9 seconds, 8 seconds and the like) shorter than that of the first day after the second day by increasing a proficiency level for a task. The notification unit 104 notifies the change amount of the average value of the longest periods as a change amount of a time required for a task.

Furthermore, as illustrated in FIG. 3, it is assumed that even though the shortened width of working hours is large for the first several days, the shortened width is gradually reduced after the third day. It is assumed that a worker's proficiency level for a task is increased with the passage of time and working hours are shortened. Furthermore, it is assumed that the shortened width of working hours, that is, a change amount of the working hours is reduced with the passage of time. By receiving a change amount of a time required for a worker's task from the notification unit 104, a supervisor can understand a change in a worker's proficiency level for a task.

After completing the notification of the change amount as the index of the effect due to habituation, the notification of the change amount as the index of the influence due to fatigue, and the notification of the change amount as the index indicating the proficiency level, the action analysis device 100 ends the analyzing process.

When the action analysis device of the present example embodiment is used, analysis of an influence to productivity of a worker due to learning effect, fatigue, and knowledge (suitability) of a subject in respectively processes, peripheral environments such as air temperature, and the like becomes easy.

The reason for this is because the analysis unit 103 calculates a change amount of productivity due to an influence of a proficiency level and fatigue from a change of periodicity and the size of a variation amount of calculated each period, and the notification unit 104 provides calculated values.

Furthermore, when the action analysis device of the present example embodiment is used, productivity of a worker is easily calculated. The reason for this is because reference data used in a general action analysis device is not used in the present example embodiment and thus processes such as generation and collation of the reference data are not required.

The action analysis device 100 of the present example embodiment can understand a change in a time required for a task due to an influence of a proficiency level and fatigue by using no reference value without applying a large burden to a subject. The reason for this is because work sounds to be analyzed are sounds naturally generated in a task of the subject and no burden to the subject occurs in acquisition. Furthermore, this is because the analysis unit 103 checks a time-dependent change of a frequency analysis result of data acquired for a predetermined time and thus no reference data is used.

### Example Embodiment 2

### [Description of Configuration]

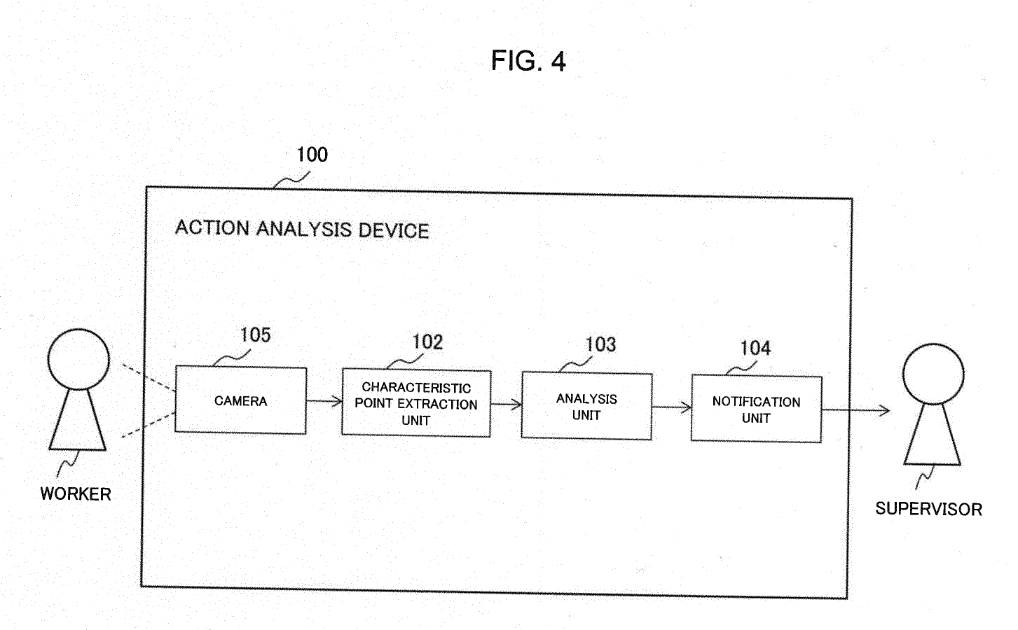

Next, a second example embodiment of the present invention will be described with reference to the drawings. FIG. 4 is a block diagram illustrating a configuration example of the second example embodiment of an action analysis device according to the present invention.

As illustrated in FIG. 4, an action analysis device 100 of the present example embodiment is different from the action analysis device 100 illustrated in FIG. 1 in that a camera 105 is provided instead of the mike 101. The configuration of the action analysis device 100 illustrated in FIG. 4, except for the camera 105, is similar to the configuration of the action analysis device 100 illustrated in FIG. 1.

The camera 105 has a function of capturing working situations of a worker. For example, the camera 105 captures working situations of a worker as a video. Furthermore, the camera 105 may capture working situations of a worker as an image.

Furthermore, the characteristic point extraction unit 102 of the present example embodiment has a function of extracting a point, in which a time change in brightness is large, from the video and the like inputted from the camera 105 as a characteristic point.

For example, a case, where the camera 105 captures the aforementioned series of tasks by the worker as a video from a task start time, is considered. It is assumed that a hand of the worker passes once the vicinity of the box A, the vicinity of the box B, the vicinity of the box C, and the vicinity of the table, on which the parts a and parts b are placed, in a one-time task.

That is, if the color of the hand of the worker is different from a background color, the brightness of the vicinity of the box A, the brightness of the vicinity of the box B, the brightness of the vicinity of the box C, and the brightness of the vicinity of the table, on which the parts a and parts b are placed, in the video captured by the camera 105 are changed once in the one-time task. Furthermore, since the action of a hand of a skillful worker having a short task time is fast, the brightness of each place is quickly changed.

Thus, since a time change in the brightness in the video and the like may be an analysis object, the characteristic point extraction unit 102 extracts a point, in which the time change in the brightness is large in the video and the like inputted from the camera 105, as a characteristic point.

Furthermore, the characteristic point extraction unit 102 may extract a point, in which a time change in a color (a hue) is large in the video and the like inputted from the camera 105, as a characteristic point. When the characteristic point extraction unit 102 extracts the point, in which the time change in the color is large, as the characteristic point, the action analysis device 100 of the present example embodiment, for example, can process a color video and the like, in which only a color is changed without a change in brightness.

An analysis unit 103 of the present example embodiment receives the characteristic point, in which the time change in the brightness or the time change in the color is large in the video and the like, from the characteristic point extraction unit 102.

In addition, as the camera 105, it is possible to use a portable telephone such as a smart phone having a capturing function.

### [Description of Operation]

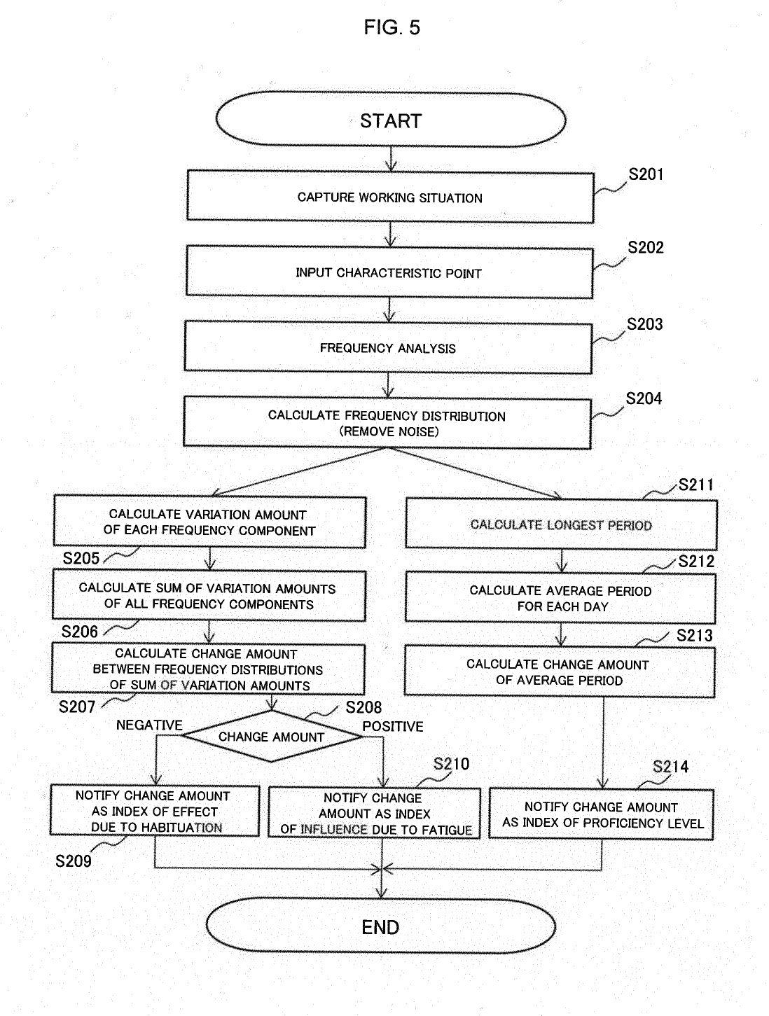

Hereinafter, the operations of the action analysis device 100 of the present example embodiment will be described with reference to FIG. 5. FIG. 5 is a flowchart illustrating operations of the analyzing process by the action analysis device 100 of the second example embodiment.

The camera 105 captures working situations of a worker for a predetermined time (step S201). In the present example, the camera 105 captures the working situations of the worker as a video. The camera 105 inputs the captured video to the characteristic point extraction unit 102.

Next, the characteristic point extraction unit 102 extracts a point, in which a time change in brightness or a time change in a color is large in the video inputted from the camera 105, as a characteristic point. The characteristic point extraction unit 102 inputs the extracted characteristic point to the analysis unit 103 (step S202).

Next, the analysis unit 103 performs frequency analysis with respect to a time change amount of the brightness of the video or a time change amount of the color of the video in the inputted characteristic point, thereby analyzing the time change amount into frequency components (step S203).

Since processes of step S204 to step S214 are similar to those of step S104 to step S114 of the first example embodiment illustrated in FIG. 2, a description thereof will be omitted.

According to the present example embodiment, the action analysis device 100 can understand a change in a time required for a task more precisely. The reason for this is because the camera can recognize a change in many tasks as compared with the mike of the first example embodiment.

### Example Embodiment 3

### [Description of Configuration]

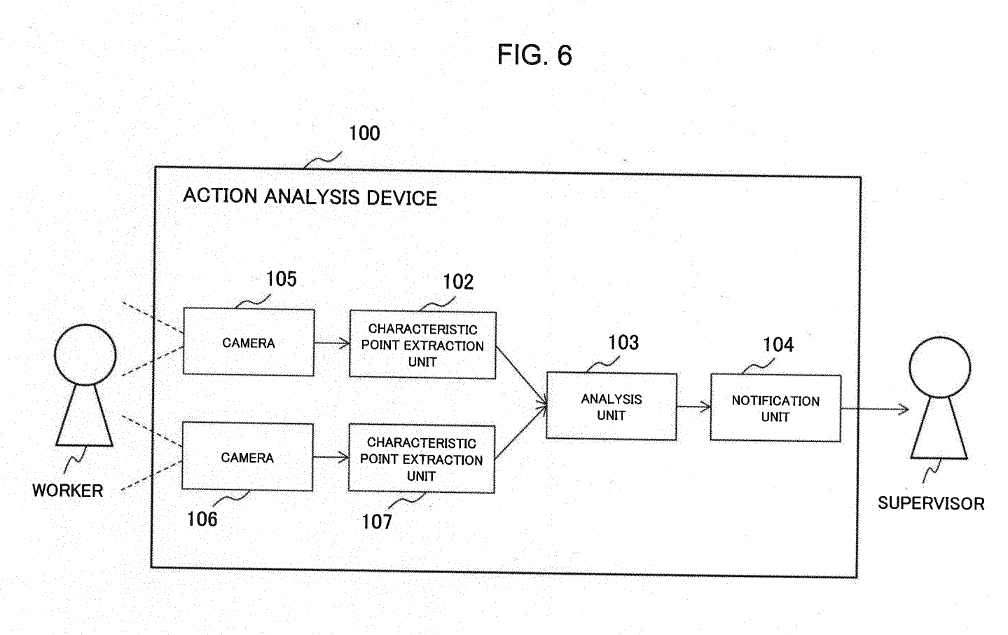

Next, a third example embodiment of the present invention will be described with reference to the drawings. FIG. 6 is a block diagram illustrating a configuration example of the third example embodiment of an action analysis device according to the present invention.

As illustrated in FIG. 6, an action analysis device 100 of the present example embodiment is different from the action analysis device 100 illustrated in FIG. 4 in that a camera 106 and a characteristic point extraction unit 107 are provided. The configuration of the action analysis device 100 illustrated in FIG. 6, except for the camera 106 and the characteristic point extraction unit 107, is similar to the configuration of the action analysis device 100 illustrated in FIG. 4. In addition, the action analysis device 100 may include three or more cameras.

The camera 105 and the camera 106 capture different types of videos and the like, respectively. That is, characteristic points respectively extracted by the characteristic point extraction unit 102 and the characteristic point extraction unit 107 are different from each other.

In addition, the characteristic point extraction unit 102 or the characteristic point extraction unit 107 may respectively extract a plurality of characteristic points from a video and the like captured by one camera.

An analysis unit 103 of the present example embodiment performs frequency analysis with respect to a time change amount of the brightness of the video or a time change amount of the color of the video in the inputted respective characteristic points, thereby generating frequency distributions of frequency components, respectively. Furthermore, the analysis unit 103 adds up the generated frequency distributions corresponding to the characteristic points and analyzes newly generated frequency distributions.

### [Description of Operation]

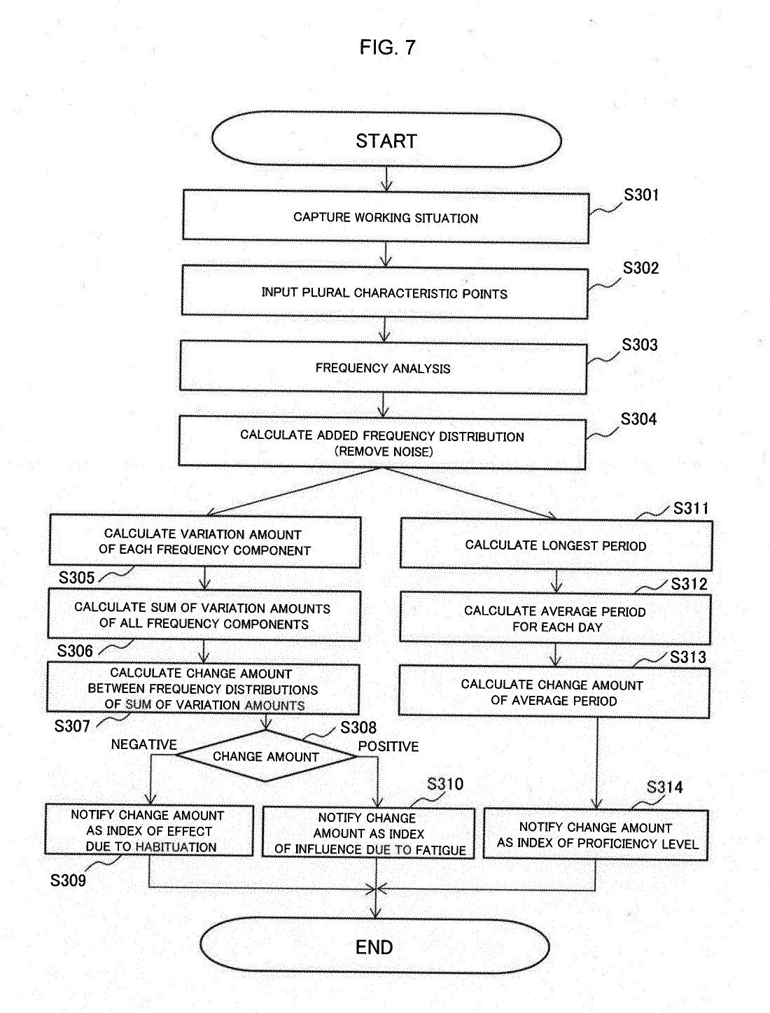

Hereinafter, the operations of the action analysis device 100 of the present example embodiment will be described with reference to FIG. 7. FIG. 7 is a flowchart illustrating operations of the analyzing process by the action analysis device 100 of the third example embodiment.

The camera 105 and the camera 106 capture working situations of a worker for a predetermined time (step S301). In the present example, the camera 105 and the camera 106 capture the working situations of the worker as videos.

Next, the camera 105 inputs the captured video to the characteristic point extraction unit 102. Furthermore, the camera 106 inputs the captured video to the characteristic point extraction unit 107.

Next, the characteristic point extraction unit 102 extracts a point, in which a time change in brightness or a time change in a color is large in the video inputted from the camera 105, as a characteristic point. The characteristic point extraction unit 102 inputs the extracted characteristic point to the analysis unit 103.

Furthermore, the characteristic point extraction unit 107 extracts a point, in which a time change in brightness or a time change in a color is large in the video inputted from the camera 106, as a characteristic point. The characteristic point extraction unit 107 inputs the extracted characteristic point to the analysis unit 103 (step S302).

Next, the analysis unit 103 performs frequency analysis with respect to a time change amount of the brightness of the video or a time change amount of the color of the video in the inputted each characteristic point, thereby analyzing the time change amount into frequency components. The analysis unit 103 adds up frequency distributions obtained by the frequency analysis and corresponding to the characteristic points, and generates new frequency distributions (step S303).

Since processes of step S304 to step S314 are similar to those of step S104 to step S114 of the first example embodiment illustrated in FIG. 2, a description thereof will be omitted.

According to the action analysis device 100 of the present example embodiment, it is possible to calculate a more accurate index indicating productivity of a task. The reason for this is because a plurality of characteristic points can be extracted from videos and the like captured by a plurality of cameras and the analysis unit can obtain many frequency distributions.

### Example Embodiment 4

### [Description of Configuration]

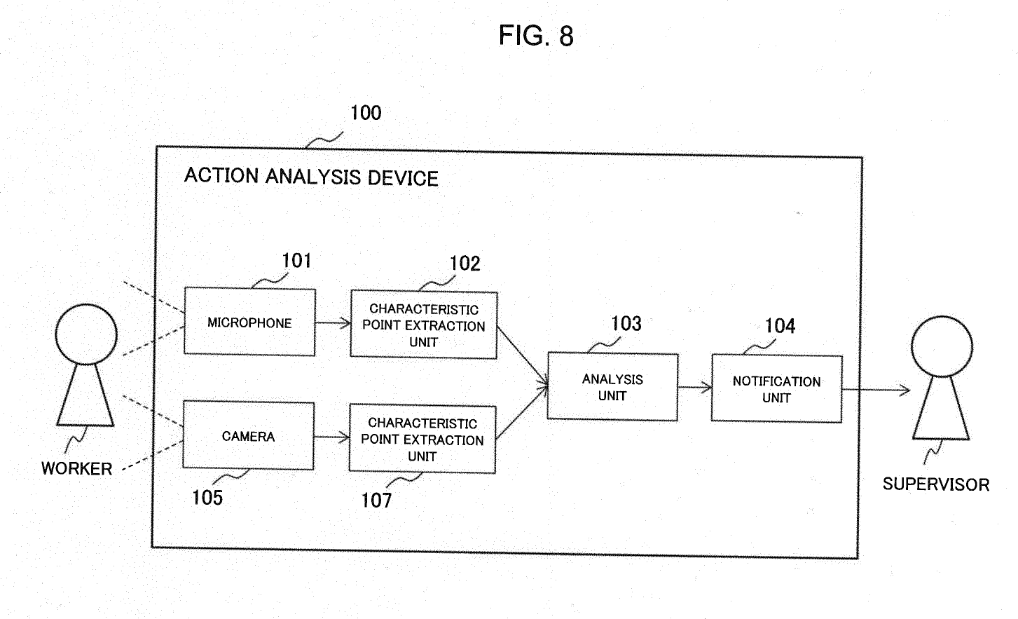

Next, a fourth example embodiment of the present invention will be described with reference to the drawings. FIG. 8 is a block diagram illustrating a configuration example of the fourth example embodiment of an action analysis device according to the present invention.

As illustrated in FIG. 8, an action analysis device 100 of the present example embodiment is different from the action analysis device 100 illustrated in FIG. 1 in that a camera 105 and a characteristic point extraction unit 107 are provided. The configuration of the action analysis device 100 illustrated in FIG. 8, except for the camera 105 and the characteristic point extraction unit 107, is similar to the configuration of the action analysis device 100 illustrated in FIG. 1. In addition, the action analysis device 100 may include two or more mikes and cameras, respectively.

As described above, the mike 101 collects sounds including work sounds generated in a task of a worker. Furthermore, the camera 105 captures work situations of the worker. That is, the types of information respectively extracted by the characteristic point extraction unit 102 and the characteristic point extraction unit 107 are different from each other.

The analysis unit 103 of the present example embodiment performs frequency analysis with respect to a time change amount regarding the respective information inputted from the characteristic point extraction unit 102 and the characteristic point extraction unit 107, thereby generating frequency distributions of frequency components, respectively. Furthermore, the analysis unit 103 adds up the generated frequency distributions and analyzes newly generated frequency distributions.

### [Description of Operation]

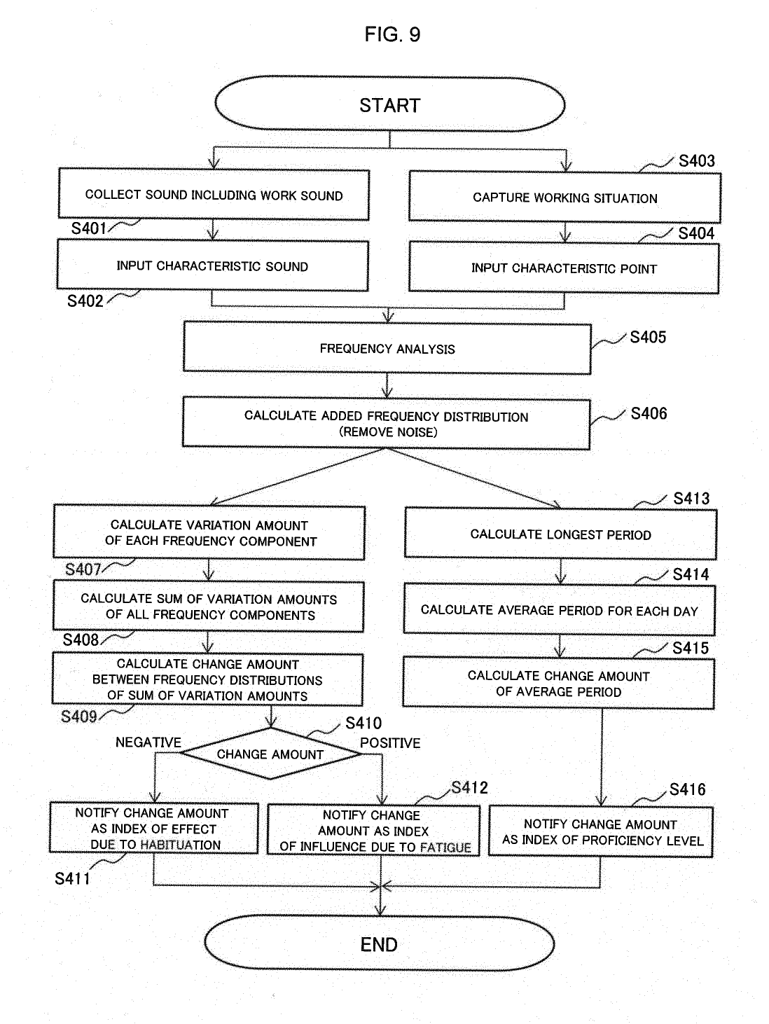

Hereinafter, the operations of the action analysis device 100 of the present example embodiment will be described with reference to FIG. 9. FIG. 9 is a flowchart illustrating operations of the analyzing process by the action analysis device 100 of the fourth example embodiment.

The mike 101 collect sounds, which include work sounds generated in a task of a worker, for a predetermined time (step S401). Next, the mike 101 inputs the collected sounds to the characteristic point extraction unit 102.

Next, the characteristic point extraction unit 102 extracts a sound, in which a time change is large, from the inputted sounds. The characteristic point extraction unit 102 inputs the extracted sound to the analysis unit 103 (step S402).

Furthermore, the camera 105 captures working situations of the worker for a predetermined time (step S403). In the present example, the camera 105 captures the working situations of the worker as a video. Next, the camera 105 inputs the captured video to the characteristic point extraction unit 107.

Next, the characteristic point extraction unit 107 extracts a point, in which a time change in brightness or a time change in a color is large in the video inputted from the camera 105, as a characteristic point. The characteristic point extraction unit 107 inputs the extracted characteristic point to the analysis unit 103 (step S404).

Next, the analysis unit 103 performs frequency analysis with respect to a time change amount regarding the inputted each information, thereby analyzing the time change amount into frequency components. The analysis unit 103 adds up the frequency distributions obtained by the frequency analysis and generates new frequency distributions (step S405).

Since processes of step S406 to step S416 are similar to those of step S104 to step S114 of the first example embodiment illustrated in FIG. 2, a description thereof will be omitted.

The action analysis device 100 of the present example embodiment can calculate a more accurate index indicating productivity of a task. The reason for this is because the analysis unit can obtain many frequency distributions from different types of time change amounts acquired by a plurality of devices.

### Example

### [Description of Configuration]

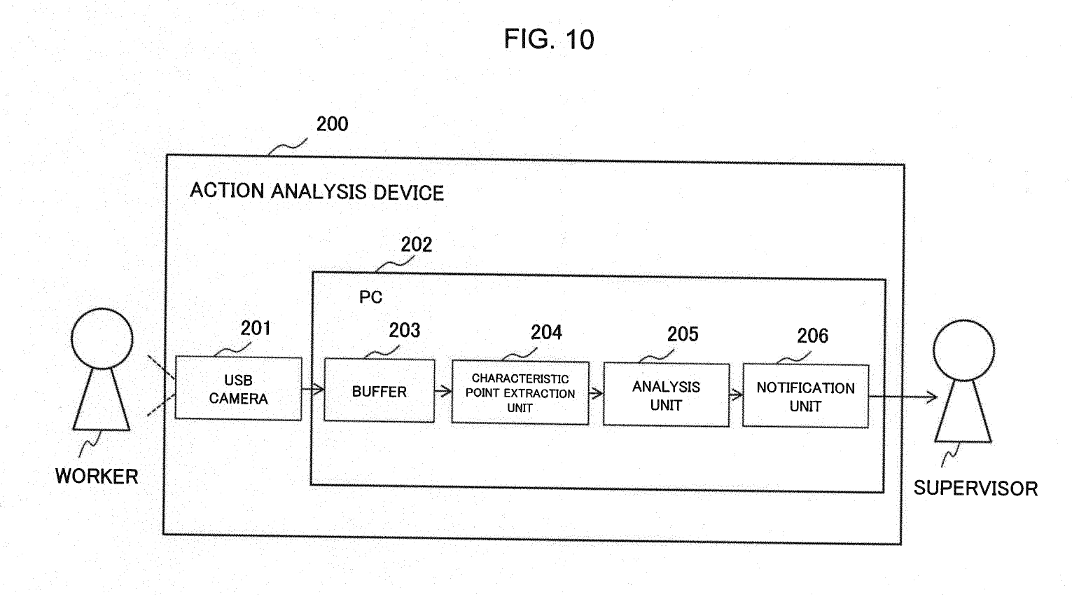

Next, examples of the present invention will be described with reference to the drawings. FIG. 10 is a block diagram illustrating a configuration example of the present example of an action analysis device according to the present invention. An action analysis device 200 in the present example quantifies productivity of a worker working in a production line of a factory.

As illustrated in FIG. 10, the action analysis device 200 includes a universal serial bus (USB) camera 201 and a personal computer (hereinafter, referred to as PC) 202. The PC 202 includes a buffer 203, a characteristic point extraction unit 204, an analysis unit 205, and a notification unit 206.

The USB camera 201, the characteristic point extraction unit 204, the analysis unit 205, and the notification unit 206 have functions similar to those of the camera 105, the characteristic point extraction unit 102, the analysis unit 103, and the notification unit 104, respectively.

Furthermore, for the PC 202 illustrated in FIG. 10, general video capture software is introduced. The video capture software edits videos captured by the USB camera 201 and stores the edited videos in the buffer 203. As illustrated in FIG. 10, the action analysis device of the second example embodiment is implemented using the USB camera and the PC with the introduced video capture software.

### [Description of Operation]

Hereinafter, the operations of the action analysis device 200 of the present example will be described with reference to FIG. 5.

The USB camera 201 captures working situations of a worker for a predetermined time (step S201). The video capture software edits the video captured by the USB camera 201 and then stores the edited video in the buffer 203.

The characteristic point extraction unit 204, for example, receives a bitmap with the size of 640×480 pixels by the 10 frames per second from the buffer 203. The characteristic point extraction unit 204 calculates moving average of brightness of each of all the pixels in the past one second (10 frames) by using a commercial library for calculating brightness of pixels of a designated coordinate. In the present example, the number of all pixels is 307,200 (640×480).

Next, the characteristic point extraction unit 204 calculates the number of times by which brightness has been changed more than a predetermined value in the closest 60 seconds in relation to all the pixels. The characteristic point extraction unit 204 selects a pixel with the largest number of times, by which the brightness has been changed, as a characteristic point. The characteristic point extraction unit 204 inputs the selected characteristic point to the analysis unit 205 (step S202).

Next, the analysis unit 205 performs frequency analysis with respect to a time change amount of the brightness of the video in the inputted characteristic point, thereby analyzing the time change amount into frequency components (step S203). The analysis unit 205 removes noise and the like from the obtained result, thereby generating frequency distributions of the frequency components (step S204).

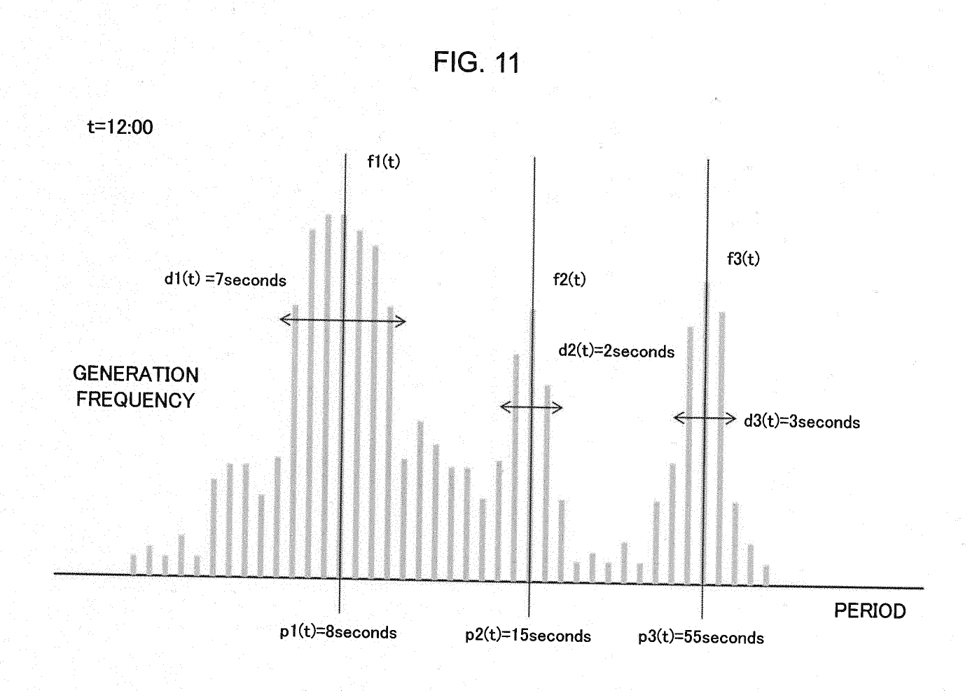

For example, a case, where frequency distributions illustrated in FIG. 11 are obtained in the process of step S204, is considered. FIG. 11 is an explanation diagram illustrating an example of frequency distributions of frequency components generated by the analysis unit 205 in the present example. The frequency distributions illustrated in FIG. 11, for example, are generated by converting a horizontal axis of the frequency distributions of the frequency components into a period.

In the frequency distributions illustrated in FIG. 11, it is assumed that the frequency of each frequency component of 8 seconds, 15 seconds, and 55 seconds has a maximum value. The frequency of each frequency component of 8 seconds, 15 seconds, and 55 seconds is called f1(t), f2(t), and f3(t), respectively. In addition, t denotes a time at which acquisition of data to be subjected to frequency analysis has been started.

Next, the analysis unit 205 calculates a variation amount of each frequency component of 8 seconds, 15 seconds, and 55 seconds for each frequency distribution (step S205).

In the case of a periodical component of 8 seconds, the analysis unit 205 calculates a place where frequency more than a value obtained by multiplying f1(t) by a predetermined ratio has been separated from f1(t) illustrated in FIG. 11. In the present example, a distance, which is obtained by adding a distance between minimum frequency located from the left from f1(t) and satisfying a predetermined condition and f1(t) to a distance between minimum frequency located from the right from f1(t) and satisfying a predetermined condition and f1(t), is assumed as a variation amount of the periodical component of 8 seconds. The variation amount of the periodical component of 8 seconds is called d1(t).

In addition, in the present example, for the purpose of convenience, a unit of the variation amount is assumed as a second in accordance with the horizontal axis of the frequency distributions. The unit of the variation amount may be any units if the variation amount corresponds to a distance between the frequency distributions.

Similar to the periodical component of 8 seconds, the analysis unit 205 also calculates variation amounts of the frequency components with respect to the periodical component of 15 seconds and the periodical component of 55 seconds. The variation amount of the periodical component of 15 seconds and the variation amount of the periodical component of 55 seconds are called d2(t) and d3(t), respectively.

The frequency distributions illustrated in FIG. 11 are frequency distributions obtained by performing frequency analysis with respect to videos corresponding to one hour from 12 o'clock to 13 o'clock. For example, d1(t), d2(t), and d3(t) are respectively assumed to have the following values.

d1(12:00)=7 seconds, d2(12:00)=2 seconds, and d3(12:00)=3 seconds

Similarly, in a frequency distribution corresponding to videos from 13 o'clock to 14 o'clock, a frequency distribution corresponding to videos from 14 o'clock to 15 o'clock, and a frequency distribution corresponding to videos from 15 o'clock to 16 o'clock, d1(t), d2(t), and d3(t) are respectively assumed to have the following values for example.

d1(13:00)=6 seconds, d2(13:00)=3 seconds, and d3(13:00)=3 seconds

d1(14:00)=9 seconds, d2(14:00)=3 seconds, and d3(14:00)=2 seconds

d1(15:00)=7 seconds, d2(15:00)=2 seconds, and d3(15:00)=3 seconds

Next, the analysis unit 205 calculates the sum S(t)(=d1(t)+d2(t)+d3(t)) of the variation amounts of the periodical component for each frequency distribution (step S206).

Next, the analysis unit 205 calculates a change amount S(t+Δt)−S(t) of the sum of the variation amounts between the frequency distributions (step S207). The analysis unit 205 determines whether the calculated change amount of the sum of the variation amounts with the passage of time is negative, that is, whether the sum of the variation amounts is decreased (step S208). In the present example, Δt is one hour.

When S(t+Δt)−S(t)<0 (negative in step S208), the notification unit 206 notifies the calculated change amount |S(t+Δt)−S(t)| of the sum of the variation amounts as an index of effect due to habituation (step S209). In addition, the notification unit 206 may notify S(t+Δt)−S(t) which is the calculation result.

When S(t+Δt)−S(t)>0 (positive in step S208), the notification unit 206 notifies the calculated change amount |S(t+Δt)−S(t)| of the sum of the variation amounts as an index of an influence due to fatigue (step S210). In addition, the notification unit 206 may notify S(t+Δt)−S(t) which is the calculation result.

In parallel with the calculation of the variation amounts of the periodical components, the analysis unit 205 decides the longest period of periods corresponding to frequency having a maximum value in the frequency distributions, that is, a time required for a one-time task (step S211).

In the example of the frequency distributions illustrated in FIG. 11, the longest period of the periods corresponding to the frequency having a maximum value is a period corresponding to f3(t). In the present example, the period corresponding to f3(t) is assumed as p(t).

Next, the analysis unit 205 calculates an average period P(day) of one day of p(t) (step S212). P(day), for example, is calculated by the following Equation.

P(day)=[p(0:00)+p(1:00)+ . . . +p(23:00)]/24

In addition, P(day) may be calculated by Equations other than the aforementioned Equation. For example, in the case of analyzing a worker's task performed only in the daytime, acquired p(t) is p(9:00), p(10:00), . . . , p(17:00) for example. It is sufficient if the analysis unit 205 changes an Equation for calculating P(day) in accordance with the number of acquired p(t).

Next, the analysis unit 205 calculates a change amount |P(d+Δd)−P(d)| of the calculated average period P(day) (step S213). Ad, for example, is one day.

Next, the notification unit 206 notifies the calculated change amount as an index indicating a proficiency level (step S214). In addition, the notification unit 206 may notify P(d+Δd)−P(d) which is the calculation result.

After completing the notification of the change amount as the index of effect due to habituation, the notification of the change amount as the index of an influence due to fatigue, and the notification of the change amount as the index indicating a proficiency level, the action analysis device 200 ends the analyzing process.

In the action analysis device of the present example, the characteristic point extraction unit 204 selects a coordinate of a point in which a time change in brightness or a time change in a color is large from a video captured by a subject. Next, the analysis unit 205 performs frequency analysis with respect to a time change amount in brightness or a time change amount in a color at the selected coordinate, thereby generating frequency distributions of frequency components. The analysis unit 205 calculates a proficiency level from a variation between frequency distributions of periodical components of long duration. Furthermore, the analysis unit 205 calculates effect due to habituation or an influence due to fatigue with respect to a task from a variation between frequency distributions of variation amounts of periodical components. The notification unit 206 notifies a supervisor of the value calculated by the analysis unit 205.

Thus, the action analysis device of the present example can numerically convert a change in productivity due to an influence of a proficiency level or fatigue without increasing a burden of a worker. Since the action analysis device can understand a change in productivity without collating acquired data with reference data, a user does not need to generate reference data in advance.

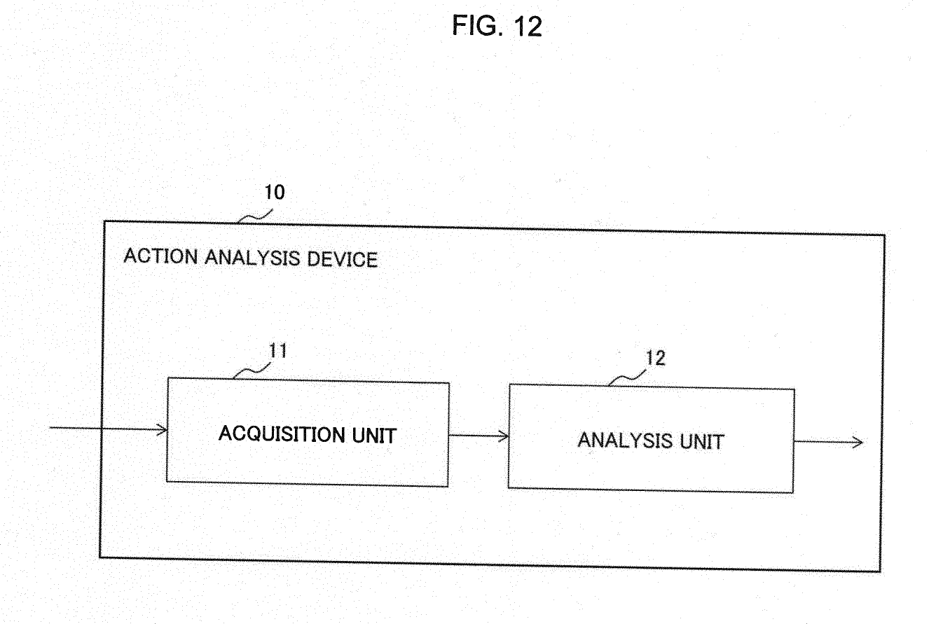

Next, the outline of the present invention will be described. FIG. 12 is a block diagram illustrating the outline of an action analysis device according to the present invention. An action analysis device 10 according to the present invention includes an acquisition unit 11 (for example, the mike 101) which acquires sounds, and an analysis unit 12 (for example, the analysis unit 103) which analyzes the frequency of the acquired sounds per predetermined time interval, wherein the analysis unit 12 compares frequency distributions of frequency components within each frequency distribution which is the frequency analysis result, the frequency components corresponding to work sounds generated in a predetermined task performed by a subject, and thereby generates information indicating a change in a time required for the predetermined task of the subject with the passage of time.

By such a configuration, the action analysis device can understand a change in a time required for a task due to an influence of a proficiency level and fatigue by using no reference value without applying a large burden to the subject.

Furthermore, the action analysis device 10 may include an extraction unit (for example, the characteristic point extraction unit 102) that extracts a sound, in which a time change is the largest, from a plurality of different types of sounds acquired by the acquisition unit 11.

By such a configuration, the action analysis device does not analyze sounds not required to be analyzed.

Furthermore, the acquisition unit 11 may acquire a plurality of images indicating a subject who performs a predetermined task, and the extraction unit may extract a place where a time change in brightness or a time change in a color is the largest in the plurality of acquired images. The analysis unit 12 may analyze the frequency of time series data of the brightness or time series data of the color in the extracted place per predetermined time interval, and compare frequency distributions of frequency components within each frequency distribution which is the frequency analysis result, the frequency components corresponding to the time change in brightness or the time change in a color generated in a predetermined task, and thereby generate information indicating a change in a time required for a predetermined task of a subject with the passage of time, wherein the time series data is obtained from the plurality of images.

By such a configuration, the action analysis device can understand the change in the time required for the task of the subject by using a video obtained by capturing a state of the task of the subject.

Furthermore, the action analysis device 10 may include a notification unit (for example, the notification unit 104) that notifies the generated information indicating the change in the time required for the predetermined task.

By such a configuration, the action analysis device can notify a supervisor of the change in the time required for the task of the subject.

Furthermore, the analysis unit 12 may specify frequency components for a predetermined task in which frequency has a maximum value in the frequency distributions, acquire a value of a width in the frequency distributions from the specified frequency components to frequency components satisfying a predetermined condition, and generate a change amount of the value of the width acquired from each frequency distribution with the passage of time as information indicating the change in the time required for the predetermined task.

By such a configuration, the action analysis device can understand a change in the degree of a variation in the time required for the task of the subject.

Furthermore, the analysis unit 12 may put character information “effect due to habituation for predetermined task of subject” into a negative change amount, and put character information “influence due to fatigue of subject” into a positive change amount.

By such a configuration, the action analysis device can notify a supervisor of a change in the task of the subject, which is indicated by the change in the degree of the variation in the time required for the task of the subject.

Furthermore, the analysis unit 12 may specify the longest periods from periods corresponding to frequency components for a predetermined task in which frequency has a maximum value in the frequency distributions, and generate a change amount of the longest periods specified in each frequency distribution with the passage of time as information indicating the change in the time required for the predetermined task.

By such a configuration, the action analysis device can understand a change in a time required for a subject's task corresponding to one process.

Furthermore, the analysis unit 12 may calculate an average value of the longest periods in each working day specified in each frequency distribution, and generate a change amount of the calculated each average value with the passage of time as information indicating the change in the time required for the predetermined task.

By such a configuration, the action analysis device can understand a variation per day of the time required for the subject's task corresponding to one process.

Furthermore, the analysis unit 12 may analyze the frequency of volume in the acquired sounds, volume of a specific musical interval, or a musical interval per predetermined time interval.

Furthermore, the acquisition unit 11 may acquire a plurality of images indicating a subject who performs a predetermined task, and the extraction unit may extract a plurality of places where a time change in brightness or a time change in a color is large in the plurality of acquired images. The analysis unit 12 may analyze the frequency of time series data of the brightness or time series data of the color in the extracted each place, add up each frequency distribution which is the frequency analysis result, and compare the added frequency distributions with one another, wherein the time series data is acquired from the plurality of images.

Furthermore, the analysis unit 12 may add up the frequency distributions obtained by analyzing the frequency of the sounds and the frequency distributions obtained by analyzing the frequency of the time series data of the brightness or the time series data of the color, and compare the added frequency distributions with one another.

So far, the present invention has been described with reference to the example embodiments and the examples; however, the present invention is not limited to the aforementioned example embodiments and examples. Various modifications which can be understood by a person skilled in the art can be made to the configuration and details of the present invention within the scope thereof.

This application is based on Japanese Patent Application No. 2015-117230 filed on Jun. 10, 2015, the contents of which are incorporated herein by reference.

### INDUSTRIAL APPLICABILITY

The present invention can be appropriately applied in order to quantitatively understand productivity of a worker working in a factory, a cooking place, a side job, traffic control and the like. Furthermore, the present invention can also be appropriately applied in order to analyze an influence by which a peripheral environment such as air temperature applies productivity of a worker. Moreover, the present invention can also be appropriately applied in order to detect deterioration of a machine tool which performs a repetitive operation.

### REFERENCE SIGNS LIST

10, 100, 200 action analysis device
11 acquisition unit
12 analysis unit
101 microphone (mike)
102, 107, 204 characteristic point extraction unit
103, 205 analysis unit
104, 206 notification unit
105, 106 camera
201 USB camera
202 PC
203 buffer

What is claimed is:

1. An action analysis device comprising:
an acquisition unit that acquires sounds; and
an analysis unit that analyzes a frequency of the acquired sounds per predetermined time interval,
wherein the analysis unit compares frequency distributions of frequency components within each frequency distribution which is a frequency analysis result, the frequency components corresponding to a work sound generated in a predetermined task performed by a subject, and thereby generates information indicating a change in a time required for the predetermined task of the subject with passage of time.

2. The action analysis device according to claim 1, comprising:
an extraction unit that extracts a sound, in which a time change is largest, from a plurality of different types of sounds acquired by the acquisition unit.

3. The action analysis device according to claim 1, wherein the acquisition unit acquires a plurality of images indicating a subject who performs a predetermined task,
the extraction unit extracts a place where a time change in brightness or a time change in a color is largest in the plurality of acquired images, and
the analysis unit analyzes a frequency of time series data of the brightness or time series data of the color in the extracted place, which are acquired from the plurality of images, compares frequency distributions of frequency components within each frequency distribution which is a frequency analysis result, the frequency components corresponding to the time change in brightness or the time change in a color generated in the predetermined task, and thereby generates information indicating a change in a time required for the predetermined task of the subject with passage of time.

4. The action analysis device according to claim 1, comprising:
a notification unit that notifies the generated information indicating the change in the time required for the predetermined task.

5. The action analysis device according to claim 1, wherein the analysis unit specifies frequency components for a predetermined task in which frequency has a maximum value in the frequency distributions, acquires a value of a width in the frequency distributions from the specified frequency components to frequency components satisfying a predetermined condition, and generates a change amount of the value of the width acquired from each frequency distribution with passage of time as information indicating the change in the time required for the predetermined task.

6. The action analysis device according to claim 5, wherein the analysis unit puts character information “effect due to habituation for a predetermined task of a subject” into a negative change amount, and puts character information “influence due to fatigue of a subject” into a positive change amount.

7. The action analysis device according to claim 1, wherein the analysis unit specifies longest periods from periods corresponding to frequency components for a predetermined task in which frequency has a maximum value in the frequency distributions, and generates a change amount of the longest periods specified in each frequency distribution with passage of time as information indicating the change in the time required for the predetermined task.

8. The action analysis device according to claim 7, wherein the analysis unit calculates an average value of the longest periods in each working day specified in each frequency distribution, and generates a change amount of the calculated average value with passage of time as information indicating the change in the time required for the predetermined task.

9. An action analysis method comprising the steps of:
acquiring sounds;
analyzing a frequency of the acquired sounds per predetermined time interval; and
comparing frequency distributions of frequency components within each frequency distribution which is a frequency analysis result, the frequency components corresponding to a work sound generated in a predetermined task performed by a subject, thereby generating information indicating a change in a time required for the predetermined task of the subject with passage of time.

10. A non-transitory computer readable medium storing an action analysis program, the action analysis program causes a computer to perform:
an acquisition process for acquiring sounds;
an analysis process for analyzing a frequency of the acquired sounds per predetermined time interval; and
a generation process for comparing frequency distributions of frequency components within each frequency distribution which is a frequency analysis result, the frequency components corresponding to a work sound generated in a predetermined task performed by a subject, thereby generating information indicating a change in a time required for the predetermined task of the subject with passage of time.
